(19) United States
(12) Patent Application Publication
(10) Pub. No.: US 2024/0019746 A1
(43) Pub. Date: Jan. 18, 2024

(54) ULTRA-HIGH-POLARITY CHIRAL LIQUID CRYSTAL MATERIAL, LIQUID CRYSTAL LASER AND PREPARATION METHOD THEREFOR

(71) Applicant: SOUTH CHINA UNIVERSITY OF TECHNOLOGY, Guangzhou (CN)

(72) Inventors: Satoshi AYA, Guangzhou (CN); Mingjun HUANG, Guangzhou (CN); Hiroya NISHIKAWA, Guangzhou (CN); Jinxing LI, Guangzhou (CN); Junichi KOGO, Guangzhou (CN); Junchen ZHOU, Guangzhou (CN); Xiuhu ZHAO, Guangzhou (CN)

(73) Assignee: SOUTH CHINA UNIVERSITY OF TECHNOLOGY, Guangzhou (CN)

(21) Appl. No.: 18/034,375

(22) PCT Filed: Oct. 27, 2021
(86) PCT No.: PCT/CN2021/126815

§ 371 Date: Sep. 5, 2023

(30) Foreign Application Priority Data
Oct. 28, 2020 (CN) 202011168714.5

(51) Int. Cl. G02F 1/137; G02F 1/1337; C09K 19/20; C09K 19/34; C09K 19/58

(52) U.S. Cl. CPC G02F 1/13718; G02F 1/133723; G02F 1/133788; G02F 1/133784; C09K 19/2007; C09K 19/3402; C09K 19/586; C09K 2019/2078; C09K 2019/3422

(57) ABSTRACT

The present invention discloses an ultra-high-polarity chiral liquid crystal material, a liquid crystal laser and a preparation method therefor. The ultra-high-polarity chiral liquid crystal material has, in a certain temperature range, a high dielectric constant of ε˜10⁴ and a characteristic of extremely-strong second harmonic response 3 to 10 times as much as that of a quartz crystal, and a pitch of the ultra-high-polarity chiral liquid crystal material is adjusted within 0.1 to 1 micrometer according to a doped concentration of the chiral molecule.

### TECHNICAL FIELD

The present invention belongs to the field of preparation and application of liquid crystal materials, and particularly relates to an ultra-high-polarity chiral liquid crystal material, a liquid crystal laser, and a preparation method therefor.

### DESCRIPTION OF RELATED ART

Liquid crystal is an important optoelectronic material with extremely important application value in the fields of optoelectronic displays and spatial light modulation. Usually, nematic liquid crystals only have an orientation order and no position order. Although a single molecule has a permanent dipole moment, the probability of up and down distribution of a director is the same. Therefore, the polarity of the entire liquid crystal system is cancellative, and it does not have a ferroelectric characteristic.

In 2017, Richard Mandle and John Goodby from the University of York in the UK synthesized a wedge-shaped molecule with a large electric dipole. Research has found that the molecule exhibits an ordinary nematic phase at a high temperature, but it exhibits a novel nematic phase structure with a ferroelectric characteristic at a low temperature (less than 133° C.), i.e., the molecular arrangement generates spontaneous polarization and the dipole moment of nematic molecules become ordered in spatial distribution, forming a domain with a specific orientation. In the same year, Hiroya Nishikawa from RIKEN in Japan also discovered a polar nematic liquid crystal with an extremely-high dielectric constant, which also exhibits extremely-strong second harmonic response and other characteristics. At present, the basic research on the novel nematic phase is still in its infancy, but its extremely-strong dielectric and nonlinear optical characteristics make it highly valuable for application.

By adding a chiral molecule to the nematic liquid crystal, a cholesteric phase with a periodic helical structure can be obtained. A cholesteric liquid crystal can selectively reflect circularly polarized light with the same chirality, playing a role similar to a resonant cavity. In 1988, KOPP et al. used a cholesteric liquid crystal to achieve mirror-free lasing. However, early liquid crystal lasers required the selection of appropriate laser light dyes for doping. The cholesteric liquid crystal can form laser light emergence under the action of external excitation light, and the laser light emergence wavelength is located at the edge of the selective reflection spectrum band of the cholesteric liquid crystal. In the following decades, research on this type of “soft laser” mainly focused on changing physical mechanisms, improving laser light efficiency, laser light wavelength tuning and other aspects. However, the technology inevitably uses laser light dye doping to provide gain, and the problems such as low luminous efficiency, poor stability and fluorescence bleaching cannot be fundamentally solved. There are still great limitations in the promotion and application of this technology.

### SUMMARY

At present, a cholesteric phase laser cannot do without dye gain. The present invention utilizes an ultra-high-polarity chiral liquid crystal material to avoid this problem. The ultra-high-polarity chiral liquid crystal material has a characteristic of extremely-strong second harmonic response, does not require dye doping to provide gain, and itself can excite photons, which is still the first example in the application field of cholesteric liquid crystal lasers. Moreover, compared to traditional nonlinear crystal frequency multiplication lasers, this type of liquid crystal laser without a reflection mirror has the characteristics of small resonant cavity volume, low lasing threshold, and simple fabrication, which has a wider application prospect in optical fields.

The purpose of the present invention is implemented through the following measures:
an ultra-high-polarity chiral liquid crystal material where a class of small chiral molecules are uniformly mixed with a polar nematic liquid crystal in a certain mass ratio.

Further, the ultra-high-polarity chiral liquid crystal material includes a polar nematic liquid crystal with a mass ratio of 50% to 95% and a chiral molecule with a mass ratio of 5% to 50%; preferably, the ultra-high-polarity chiral liquid crystal material comprises a polar nematic liquid crystal with a mass ratio of 70% to 95% and a chiral molecule with a mass ratio of 5% to 30%.

Further, the polar nematic liquid crystal includes one or more of the following structural formulas:

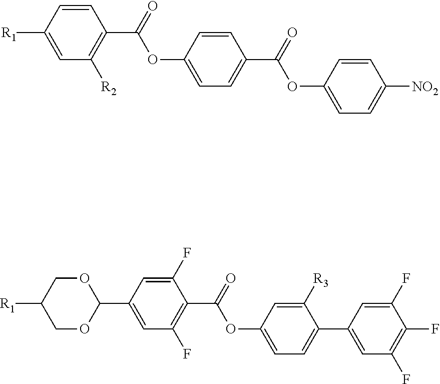

R1, R2, and R3 are alkoxy, alkyl, hydro, or fluoro groups containing 1 to 7 carbon atoms.

Further, a small chiral molecule compound has the following structural formulas:

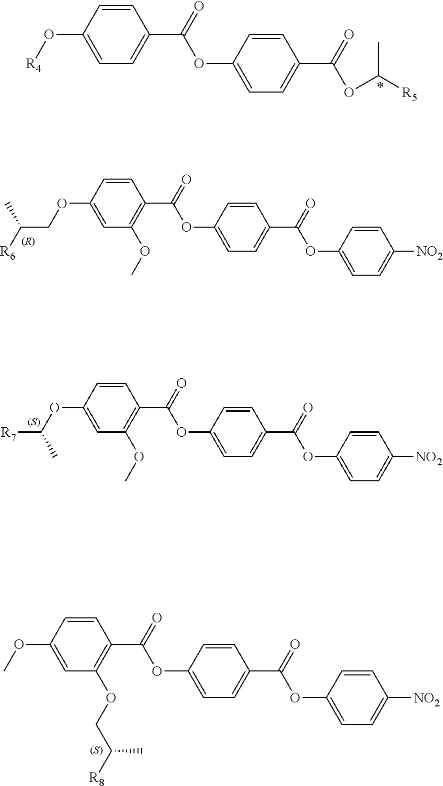

R4, R5, R6, R7 and R8 are alkyl, hydro, or fluoro groups with 1 to 7 carbon atoms.

Further, a pitch of a polar cholesteric liquid crystal can be adjusted by a concentration ratio of a chiral molecule. When a concentration of the chiral molecule can be within 5% to 50%, a pitch of a cholesteric phase can be adjusted within 0.1 to 1.0 micrometer. Correspondingly, a selective reflection edge of the cholesteric phase can continuously switch within a range of ultraviolet to infrared spectra, achieving SHG enhancement at corresponding wavelengths.

Further, the ultra-high-polarity chiral liquid crystal material has, in a certain temperature range, a high dielectric constant of ε˜10⁴ and a characteristic of extremely-strong second harmonic response 3 to 10 times as much as that of a quartz crystal.

A method for preparing a cholesteric liquid crystal laser without fluorescent molecule doping, including:
making two glass substrates aligned by polyimide parallel rubbing into a liquid crystal cell with a spacing of 5 to 20 micrometers, and injecting a mixed cholesteric liquid crystal by capillary action.

Further, the injected ultra-high-polarity chiral liquid crystal material is subjected to annealing processing for 0.5 to 2 hours under 370 to 440 K, so that a stable planar texture is formed in a cholesteric phase.

A liquid crystal laser prepared by the above method.

Further, a polar cholesteric phase of an ultra-high-polarity chiral liquid crystal material of the liquid crystal laser is planar-oriented, and has a selective reflection spectrum wavelength band adjustable from infrared to ultraviolet at different concentrations of a chiral dopant.

Further, a polar cholesteric phase of an ultra-high-polarity chiral liquid crystal material of the liquid crystal laser is capable of forming ultra-strong second harmonic response light with respect to external excitation light, the external excitation light is amplified by a second harmonic signal in a periodic structure of the polar cholesteric phase and then output as laser light, and wherein no other dye is required for gain.

Further, an ultra-high-polarity chiral liquid crystal material of the liquid crystal laser not only supplies ultra-strong second harmonic response light, but also emits high harmonic response light except second harmonic response light, the ultra-strong second harmonic response light and the high harmonic response light except second harmonic response light are amplified by a high harmonic signal in a periodic structure of a polar cholesteric phase and then output as laser light or ultra-strong high harmonic signal light, and the liquid crystal laser is equivalent to an efficient organic wavelength conversion device.

Compared with the prior art, the present invention has the following advantages and beneficial effects.

The ultra-high-polarity chiral liquid crystal material of the present invention has extremely-strong second harmonic response, and its nonlinear optical characteristic can be comparable to that of quartz in crystals, which is very rare in fluid soft materials. By changing the doping concentration of a chiral molecule, a molecular pitch can be adjusted, realizing second harmonic enhancement in the whole band from ultraviolet to infrared. Compared with existing dye doping technology, this technology avoids the problems such as photobleaching and low luminous efficiency, greatly improving the stability of a laser, and realizing low sensitivity to temperature and the ability to work in a wider temperature range. Compared with general nonlinear crystals, a liquid crystal laser can conveniently adjust the molecular pitch through the doping concentration of the chiral molecule, and have soft, easy to process, and film-forming characteristics, which can achieve work scenarios that many crystals cannot be applied to. The liquid crystal laser also has cost advantages and can be better applied in fields such as laser frequency multiplication modulation and second harmonic imaging.

### BRIEF DESCRIPTION OF DRAWINGS

FIG. 1 is a temperature dielectric spectrogram of a cholesteric phase doped with a chiral molecule with a concentration of 10% in Embodiment 1.

FIG. 2 is a DSC graph of chiral molecule doping concentrations of 5%, 10%, 20%, and 30% in Embodiments 1 to 4.

FIG. 3a is a polarizing photomicrograph of an unannealed planar cholesteric phase in Embodiment 1, with a large number of defect textures.

FIG. 3b is a polarizing photomicrograph of an annealed planar cholesteric phase in Embodiment 2.

FIG. 3c is a polarizing photomicrograph of an annealed planar cholesteric phase in Embodiment 3.

FIG. 4 is a schematic diagram of a polar cholesteric phase laser in Embodiment 6.

FIG. 5 is a temperature dependent graph of a second harmonic response signal of the polar cholesteric phase laser in Embodiment 6.

FIG. 6 shows a rotation angle dependent graph of second harmonic intensity of Y-cut quartz at a room temperature (25° C.) in Embodiment 6.

FIG. 7 is a graph of relationship between a pitch of a doped cholesteric phase and a concentration of a doped molecule in Embodiments 2 to 5.

FIG. 8 is a DSC graph of 2,4-dimethoxybenzoic acid 4-((4-nitrophenoxy)carbonyl)phenyl ester of compound 1.

FIG. 9 is a Polarizing Optical Microscope (POM) graph of 2,4-dimethoxybenzoic acid 4-((4-nitrophenoxy)carbonyl)phenyl ester of compound 1 entering a nematic phase from a liquid phase.

FIG. 10 is a POM graph of 2,4-dimethoxybenzoic acid 4-((4-nitrophenoxy)carbonyl)phenyl ester of compound 1 entering a polar nematic phase (with different directions of a director in a domain) from a nematic phase.

FIG. 11 is a three-dimensional curve graph of a dielectric strength of 2,4-dimethoxybenzoic acid 4-((4-nitrophenoxy)carbonyl)phenyl ester of compound 1 as a function of temperature and frequency, where coordinate scales corresponding to frequency (HZ) are respectively 10⁶, 10⁵, 10⁴, 10³, 10², and 10¹ from bottom left to top right, and coordinate scales corresponding to temperature (° C.) are respectively 100, 120, 140, 160, 180, and 200.

FIG. 12 is a specific value graph of SHG signal intensity of 2,4-dimethoxybenzoic acid 4-((4-nitrophenoxy)carbonyl)phenyl ester of compound 1 to quartz at different temperatures.

### DETAILED DESCRIPTION OF EMBODIMENTS

The present invention is further expounded below in combination with embodiments, but it is not intended to limit the scope of the present invention.

A chiral molecule and a polar nematic liquid crystal used in the present invention are prepared by the following methods, with corresponding dipole moment parameters as follows. Preparation methods for chiral molecules and polar nematic liquid crystals not listed are similar, and they can be prepared by referring to the following preparation methods, and have the same large dipole moment characteristic.

| Compound | Chemical structure | Dipole moment |
|---|---|---|
| 1 | 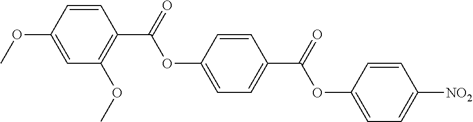 [SMILES: COc1ccc(C(=O)Oc2ccc(C(=O)Oc3ccc([N+](=O)[O-])cc3)cc2)c(OC)c1] | 11.19 |
| 2 | 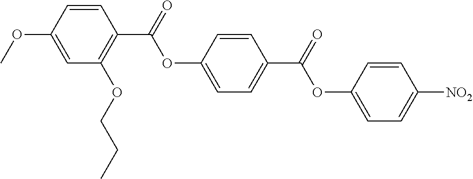 [SMILES: CCCOc1cc(OC)ccc1C(=O)Oc1ccc(C(=O)Oc2ccc([N+](=O)[O-])cc2)cc1] | 11.19 |
| 3 | 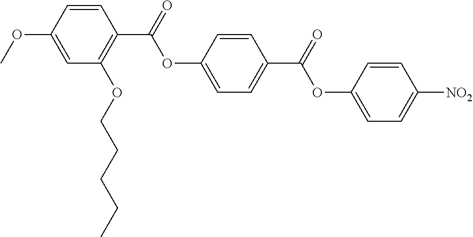 [SMILES: CCCCCOc1cc(OC)ccc1C(=O)Oc1ccc(C(=O)Oc2ccc([N+](=O)[O-])cc2)cc1] | 11.17 |
| 4 | 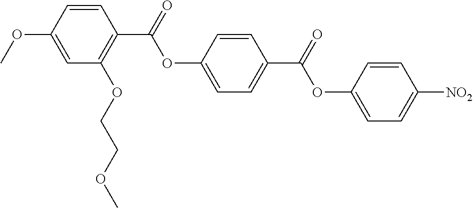 [SMILES: COCCOc1cc(OC)ccc1C(=O)Oc1ccc(C(=O)Oc2ccc([N+](=O)[O-])cc2)cc1] | 9.55 |
| 5 | 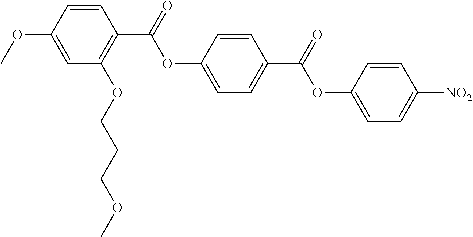 [SMILES: COCCCOc1cc(OC)ccc1C(=O)Oc1ccc(C(=O)Oc2ccc([N+](=O)[O-])cc2)cc1] | 12.28 |
| 6 | 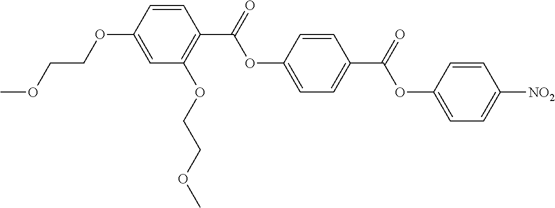 [SMILES: COCCOc1ccc(C(=O)Oc2ccc(C(=O)Oc3ccc([N+](=O)[O-])cc3)cc2)c(OCCOC)c1] | 10.85 |
| 7 | 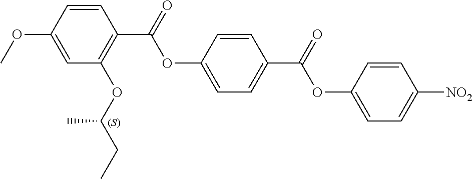 | 12.09 |
| 8 | 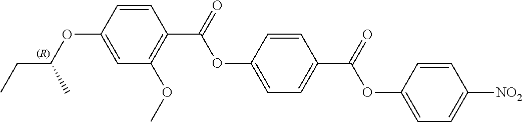 | 12.12 |
| 9 | 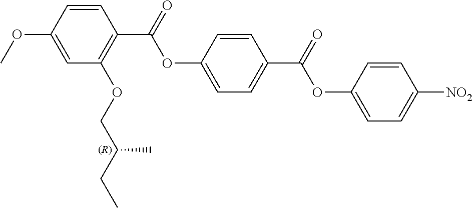 | 12.04 |
| 10 | 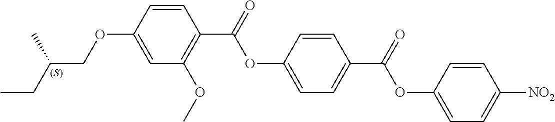 | 12.01 |
| 11 | 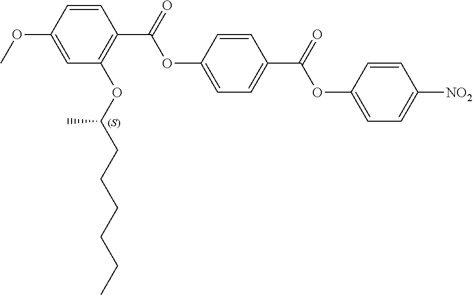 | 12.26 |
| 12 | 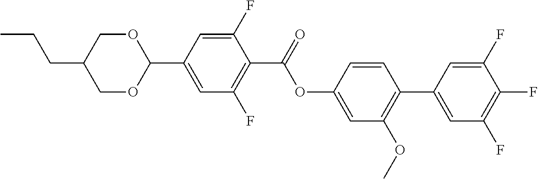 [SMILES: CCCC1COC(c2cc(F)c(C(=O)Oc3ccc(-c4cc(F)c(F)c(F)c4)c(OC)c3)c(F)c2)OC1] | 8.99 |
| 13 | 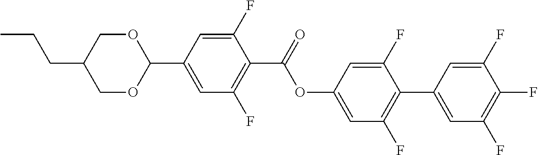 [SMILES: CCCC1COC(c2cc(F)c(C(=O)Oc3cc(F)c(-c4cc(F)c(F)c(F)c4)c(F)c3)c(F)c2)OC1] | 9.41 |

### Compound 1

### Preparation of 2,4-dimethoxybenzoic acid 4-((4-nitrophenoxy)carbonyl)phenyl ester

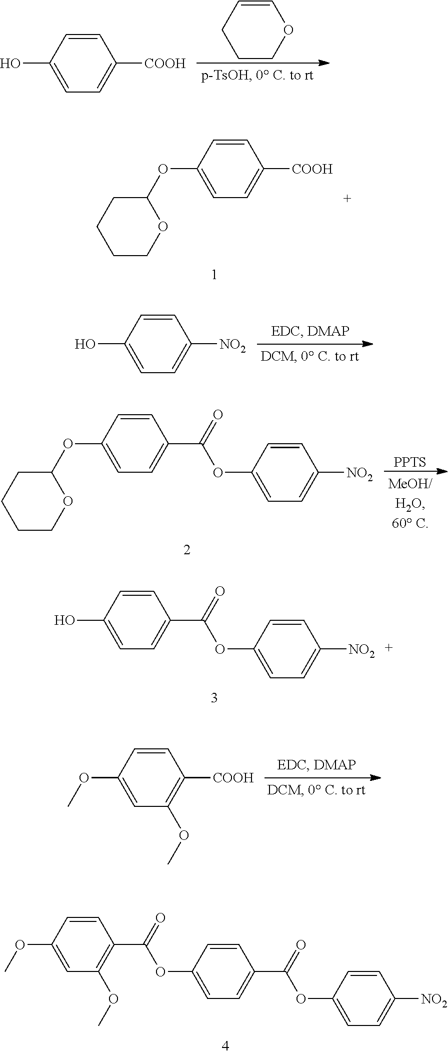

### (1) 4-((Tetrahydro-2H-pyran-2-yl)oxy)benzoic acid

Under nitrogen protection, p-hydroxybenzoic acid (2.76 g, 0.02 mol), p-toluenesulfonic acid (1.96 g, 0.0103 mol), and 20 mL of ether were added to a 50 mL single-necked flask to form a suspension. 3,4-Dihydro-2H-pyran (2.8 mL, 0.0307 mol) was added dropwise by using a syringe at 0° C. in an ice bath, and a mixture gradually restored to a room temperature and stirred for 5 to 6 hours. At this point, a large amount of precipitation is generated in the solution, and the large amount of precipitation is filtered, and is washed multiple times with 20 mL of ether, and is subjected to vacuum drying to obtain 2.89 g of white powder with a yield of 69.3%; ¹NMR (400 MHz, Chloroform-d) δ 8.06 (d, J=8.7 Hz, 2H, ArH), 7.10 (d, J=8.6 Hz, 2H, ArH), 5.53 (q, J=2.8 Hz, 1H, CH), 3.86 (d, J=21.0 Hz, 1H, CH2), 3.63 (d, J=11.2 Hz, 1H, CH2), 2.07-1.50 (m, 6H, CH2).

### (2) 4-Nitrophenyl 4-((tetrahydro-2H-pyran-2-yl)oxy)benzoate

Under nitrogen protection, compound 3 (10 g, 45 mmol), 1-(3-dimethylaminopropyl)-3-ethylcarbodiimide hydrochloride (10.35 g, 54 mmol), and N,N-dimethylaminopyridine (0.71 g, 0.54 mmol) were added to 100 mL of dichloromethane. The solution was stirred in an ice bath for 1 hour, then gradually restored to a room temperature and continued stirring for 14 to 24 hours. The reaction was monitored by TLC. After the reaction was completed, washing was conducted three times with saturated salt water, and extraction was conducted with ethyl acetate. An organic phase was dried with anhydrous magnesium sulfate, and was filtered and spin-dried. A crude product was purified by column chromatography with petroleum ether/ethyl acetate=3/1 as an eluent, so that 12 g of a white solid product with a yield of 76.8% was obtained. ¹H NMR (500 MHz, Chloroform-d) δ 8.31 (d, J=9.1 Hz, 2H, ArH), 8.12 (dd, J=17.7, 8.9 Hz, 2H, ArH), 7.40 (d, J=9.2 Hz, 2H, ArH), 7.05 (dd, J=114.9, 8.9 Hz, 2H, ArH), 5.57 (s, 1H, CH), 4.06-3.82 (m, 1H, CH2), 3.61 (d, J=55.9 Hz, 1H, CH2), 2.03-1.64 (s, 6H, CH2).

### (3) 4-Nitrophenyl 4-hydroxybenzoate

Compound 4 (1 g, 2.9 mmol), pyridinium p-toluenesulfonate (72.8 mg, 0.29 mmol), 20 mL of tetrahydrofuran, and 20 mL of methanol were added to a 100 mL single-necked flask. The mixed solution was heated to 60° C. and stirred for 6 to 24 hours until it was detected by TLC that the reaction was completed. The reaction was stopped. A temperature was reduced to a room temperature. Excess solvent was removed by rotary evaporation. Then, dissolving was conducted with ethyl acetate. Washing was conducted with deionized water. An organic phase was washed with saturated salt water, and was dried with anhydrous magnesium sulfate, and was filtered and spin-dried. A crude product was purified by column chromatography with petroleum ether/ethyl acetate=2/1 as an eluent, so that 0.72 g of a white solid product with a yield of 95.1% was obtained. ¹H NMR (400 MHz, DMSO-d6) δ 10.64 (s, 1H, OH), 8.34 (d, J=9.1 Hz, 2H, ArH), 8.02 (d, J=8.8 Hz, 2H, ArH), 7.58 (d, J=9.1 Hz, 2H, ArH), 6.95 (d, J=8.8 Hz, 2H, ArH).

### (4) 2,4-Dimethoxybenzoic acid 4-((4-nitrophenoxy)carbonyl)phenyl ester

Under nitrogen protection, compound 3 (2.35 g, 9.07 mmol), purchased 2,4-dimethoxybenzoic acid (1.73 g, 9.52 mmol), 1-(3-dimethylaminopropyl)-3-ethylcarbodiimide hydrochloride (2.6 g, 13.6 mmol), and N,N-dimethylaminopyridine (110 mg, 0.91 mmol) were added to 50 mL of anhydrous dichloromethane. The solution was stirred in an ice bath for 1 hour, then gradually restored to a room temperature and continued stirring for 14 to 24 hours. The reaction was monitored by TLC. After the reaction was completed, washing was conducted three times with saturated salt water, and extraction was conducted with ethyl acetate. An organic phase was dried with anhydrous magnesium sulfate, and was filtered and spin-dried. A crude product was purified by column chromatography with petroleum ether/dichloromethane=1/1 as an eluent, so that 2.86 g of a white solid product with a yield of 74.51% was obtained. ¹H NMR (500 MHz, Chloroform-d) δ 8.33 (d, J=9.1 Hz, 2H), 8.25 (d, J=8.7 Hz, 2H), 8.10 (d, J=8.7 Hz, 1H), 7.41 (dd, J=19.6, 8.9 Hz, 4H), 6.62-6.52 (m, 2H), 3.92 (d, J=18.6 Hz, 6H).

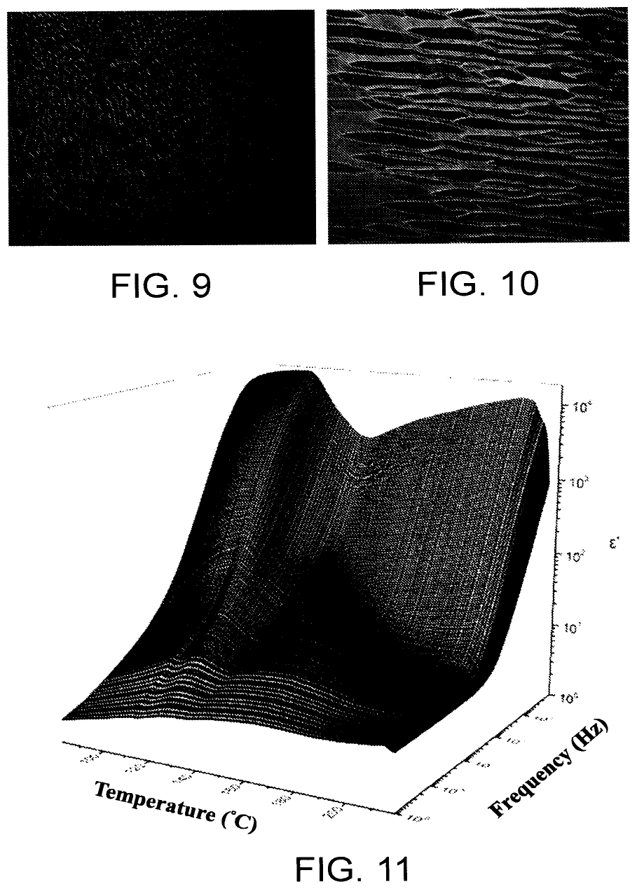

From DSC as shown in FIG. 8, there are two protrusions near 120° C. and 80° C. in a cooling curve of a liquid crystal molecule of compound 1, indicating that the molecule undergoes transition of two phases during cooling. Combined with orthogonal POM observation in a well-oriented cell, the field of view of the liquid crystal molecule changes from dark to bright when it begins to cool near a high temperature of 120° C., and the micro-orientation of a liquid crystal changes and begins to enter a nematic phase (as shown in FIG. 9). When the temperature drops to around 80° C., a refractive index undergoes a significant change. Under POM, it is observed that the field of view is significantly brightened from a dark background, and the micro-orientation of the liquid crystal changes and enters a polar nematic phase (as shown in FIG. 10). The liquid crystal molecule can exhibit a thermodynamically-stable polar nematic liquid crystal structure within a wider temperature range.

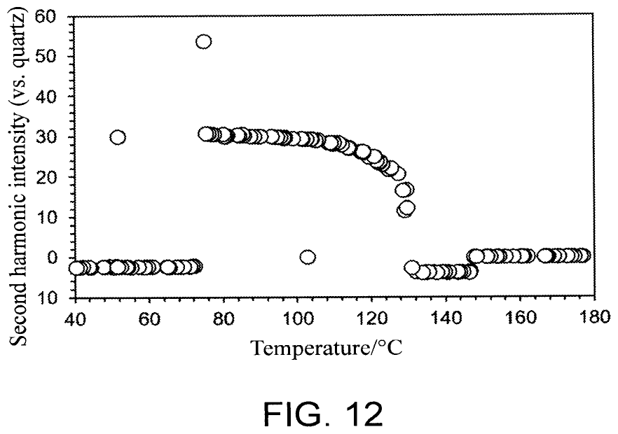

By testing a dielectric coefficient of the liquid crystal molecule throughout the entire phase transition temperature interval, it is found that the liquid crystal molecule has an extremely-high dielectric strength of 10⁴ orders of magnitude after entering a polar phase (as shown in FIG. 11), and a polar liquid crystal phase of the molecule has a good SHG response within this temperature range (as shown in FIG. 12).

### Compound 2

### Preparation of 4-methoxy-2-propoxybenzoic acid 4-((4-nitrophenoxy)carbonyl)phenyl ester (3)

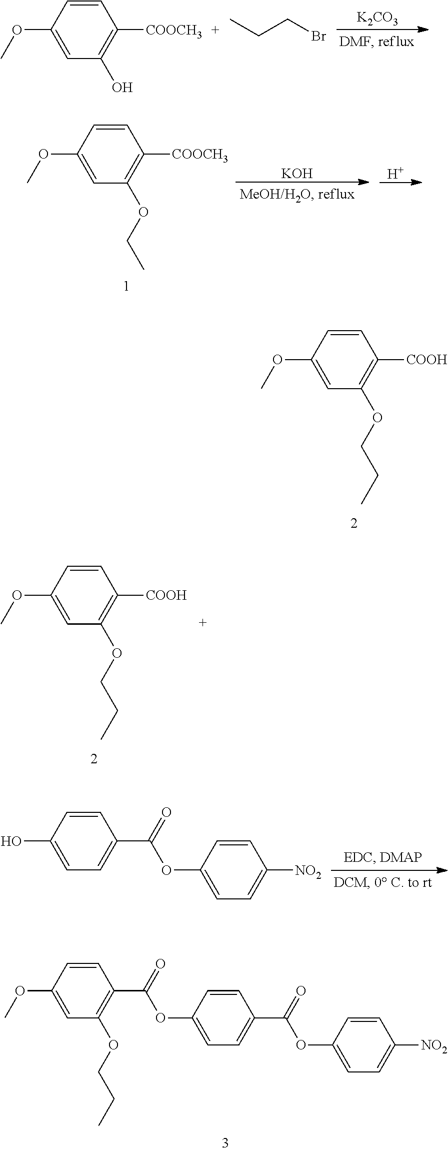

### (1) Methyl 4-methoxy-2-propoxybenzoate

Under nitrogen protection, purchased reactants methyl 2-hydroxy-4-methoxybenzoate (2 g, 10.98 mmol) and potassium carbonate (3.03 g, 21.96 mmol) were added to 30 mL of DMF, and 6-bromopropane (1.62 g, 13.17 mmol) was dropwise injected. After heating reflux for reaction overnight, washing was conducted three times with a saturated aqueous sodium chloride solution, and then extraction was conducted with ethyl acetate. After a solvent in an organic layer was spin-dried, a crude product was purified by column chromatography with petroleum ether/ethyl acetate=5/1 as an eluent, so that 2.03 g of a white powder product with a yield of 82.46% was obtained.

### (2) 4-Methoxy-2-propoxybenzoic acid

Reactant 1 (1.5 g, 6.69 mmol) was dissolved in 60 mL of a mixed solution of THF/MeOH/H₂O=1/1/1. KOH (1.5 g, 26.76 mmol) was added. The mixture was subjected to heating reflux overnight, and gradually restored to a room temperature after the reaction was completed. 200 mL of water was added. pH was adjusted to pH≈1 with a 1 M hydrochloric acid solution, and then extraction was conducted with ethyl acetate. An organic phase was dried with anhydrous magnesium sulfate, and was filtered and spin-dried. A crude product was purified by column chromatography with petroleum ether/ethyl acetate=2/1 as an eluent, so that 1.35 g of a white solid product with a yield of 96.01% was obtained.

### (3) 4-Methoxy-2-propoxybenzoic acid 4-((4-nitrophenoxy)carbonyl)phenyl ester

Under nitrogen protection, compound 2 (2 g, 9.51 mmol), 4-nitrophenyl 4-hydroxybenzoate (2.35 g, 9.06 mmol), 1-(3-dimethylaminopropyl)-3-ethylcarbodiimide hydrochloride (2.6 g, 13.6 mmol), and N,N-dimethylaminopyridine (110 mg, 0.91 mmol) were added to 50 mL of anhydrous dichloromethane. The solution was stirred in an ice bath for 1 hour, then gradually restored to a room temperature and continued stirring for 14 to 24 hours. The reaction was monitored by TLC. After the reaction was completed, washing was conducted three times with saturated salt water, and extraction was conducted with ethyl acetate. An organic phase was dried with anhydrous magnesium sulfate, filtered and spin-dried. A crude product was purified by column chromatography with petroleum ether/dichloromethane=1/1 as an eluent, so that 3.06 g of a white solid product with a yield of 74.81% was obtained. ¹H NMR (500 MHz, Chloroform-d) δ 8.38-8.31 (m, 2H), 8.26 (d, J=8.7 Hz, 2H), 8.06 (d, J=8.8 Hz, 1H), 7.46-7.41 (m, 2H), 7.39 (d, J=8.7 Hz, 2H), 6.57 (dd, J=8.8, 2.3 Hz, 1H), 6.53 (d, J=2.2 Hz, 1H), 4.03 (t, J=6.4 Hz, 2H), 3.89 (s, 3H), 1.88 (h, J=7.2 Hz, 2H), 1.07 (t, J=7.4 Hz, 3H).

### Compound 3

4-((4-Nitrophenoxy)carbonyl)phenyl 4-methoxy-2-(pentyloxy)benzoate was prepared by methods similar to those described in compound 2. ¹H NMR (400 MHz, Chloroform-d) δ 8.33 (d, J=9.1 Hz, 2H), 8.26 (d, J=8.7 Hz, 2H), 8.06 (d, J=8.7 Hz, 1H), 7.41 (dd, J=17.2, 8.9 Hz, 4H), 6.59-6.54 (m, 1H), 6.52 (d, J=2.2 Hz, 1H), 4.06 (t, J=6.5 Hz, 2H), 3.89 (s, 3H), 1.86 (dt, J=14.5, 6.6 Hz, 2H), 1.49 (dt, J=14.7, 7.1 Hz, 2H), 1.37 (dt, J=14.9, 7.2 Hz, 2H), 0.89 (t, J=7.3 Hz, 3H).

### Compound 4

4-((4-Nitrophenoxy)carbonyl)phenyl 4-methoxy-2-(2-methoxyethoxy)benzoate was prepared by methods similar to those described in compound 2. ¹H NMR (400 MHz, Chloroform-d) δ 8.31-8.23 (m, 2H), 8.23-8.16 (m, 2H), 8.00 (d, J=8.8 Hz, 1H), 7.42-7.29 (m, 4H), 6.53 (dd, J=8.8, 2.3 Hz, 1H), 6.49 (d, J=2.3 Hz, 1H), 4.21-4.11 (m, 2H), 3.82 (s, 3H), 3.79-3.70 (m, 2H), 3.37 (s, 3H).

### Compound 5

4-((4-Nitrophenoxy)carbonyl)phenyl 4-methoxy-2-(3-methoxypropoxy)benzoate was prepared by methods similar to those described in compound 2. ¹H NMR (400 MHz, Chloroform-d) δ 8.32-8.23 (m, 2H), 8.23-8.16 (m, 2H), 8.00 (d, J=8.6 Hz, 1H), 7.41-7.26 (m, 4H), 6.54-6.45 (m, 2H), 4.10 (t, J=6.2 Hz, 2H), 3.82 (s, 3H), 3.53 (t, J=6.1 Hz, 2H), 3.25 (s, 3H), 2.04 (p, J=6.1 Hz, 2H).

### Compound 6

2,4-Bis(2-methoxyethoxy)benzoic acid 4-((4-nitrophenoxy)carbonyl)phenyl ester was prepared by methods similar to those described in compound 2. ¹H NMR (400 MHz, Chloroform-d) δ 8.29-8.23 (m, 2H), 8.21-8.16 (m, 2H), 7.98 (dd, J=8.6, 1.9 Hz, 1H), 7.37-7.29 (m, 4H), 6.53 (d, J=8.7 Hz, 2H), 4.22-4.04 (m, 4H), 3.73 (dt, J=9.7, 4.6 Hz, 4H), 3.38 (d, J=14.2 Hz, 6H).

In particular, synthesis of compound methyl 2,4-bis(2-methoxyethoxy)benzoate (1) was as follows.)

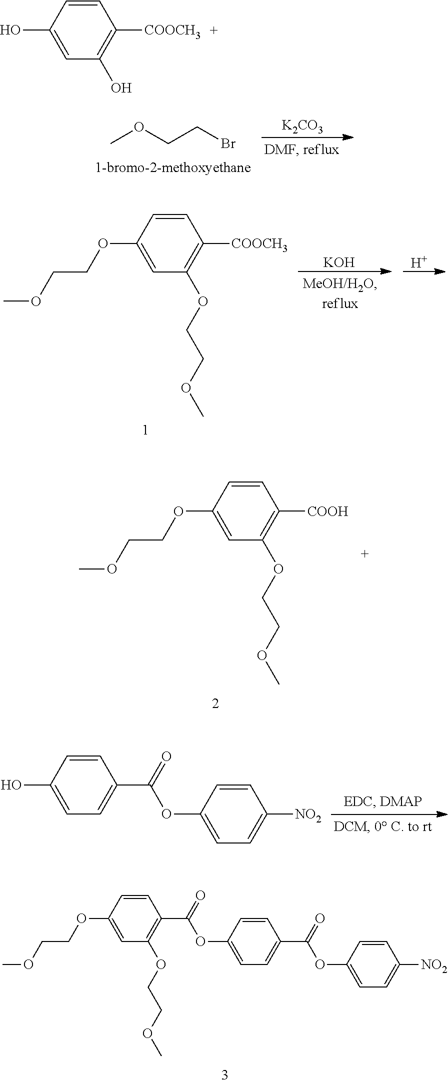

### (1) Methyl 2,4-bis(2-methoxyethoxy)benzoate

Under nitrogen protection, purchased reactants methyl 2,4-dihydroxy-benzoate (2 g, 11.89 mmol) and potassium carbonate (9.86 g, 71.37 mmol) were added to 50 mL of DMF, and 1-bromo-2-methoxyethane (3.64 g, 26.17 mmol) was dropwise injected. After heating reflux for reaction overnight, washing was conducted three times with a saturated aqueous sodium chloride solution, and then extraction was conducted with ethyl acetate. After a solvent in an organic layer was spin-dried, a crude product was purified by column chromatography with petroleum ether/ethyl acetate=5/1 as an eluent, so that 3.21 g of a white powder product with a yield of 94.9% was obtained.

### Compound 7

### Preparation of 4-((4-nitrophenoxy)carbonyl)phenyl(S)-2-(sec-butoxy)-4-methoxybenzoate (4)

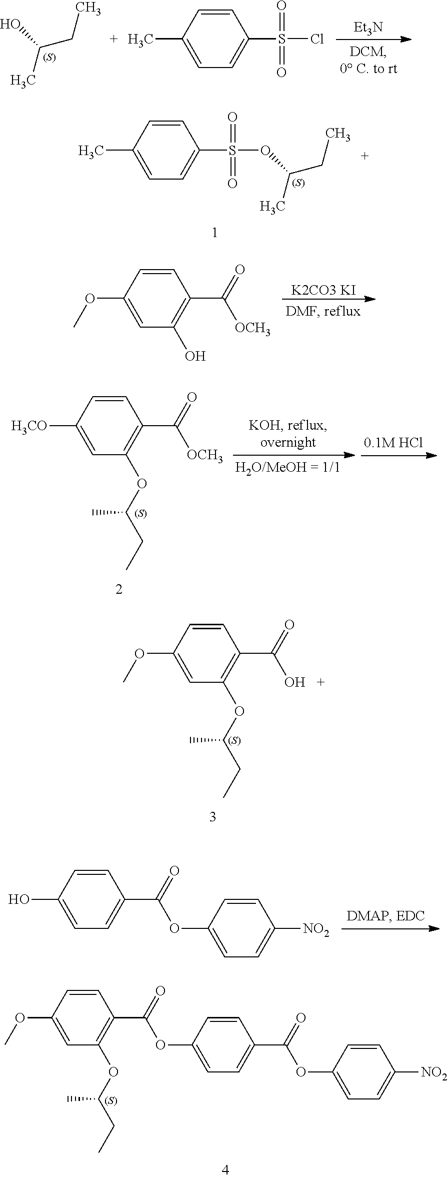

### (1) (S)sec-butyl 4-methylbenzenesulfonate

A dichloromethane solution of 4-methylbenzenesulfonyl chloride (p-TsOH) (3.86 g, 20.24 mmol) was dropwise added to a DCM solution (50 mL) of (R)-but-2-ol (1 g, 13.49 mmol), triethylamine (2.82 ml, 20.24 mmol) and N,N-dimethylaminopyridine (164 mg, 1.349 mmol) at 0° C., within 20 minutes. After the mixture was stirred at a room temperature overnight, a reaction mixture was subjected to vacuum concentration and a residue was dissolved in ethyl acetate. An obtained solution was washed with water and salt water, dried with MgSO₄, and concentrated. An oily residue was purified by column chromatography, with a yield of 73%.

### (2) Methyl(S)-2-(sec-butoxy)-4-methoxybenzoate

Under nitrogen atmosphere, (1) (1 g, 4.38 mmol), methyl 2-hydroxy-4-methoxybenzoate (0.96 g, 5.26 mmol), K₂CO₃ (1.82 g, 13.14 mmol), KI (70 mg, 0.44 mmol), and 20 mL of DMF were loaded into a round-bottom flask. The solution was subjected to heating reflux until it was judged by TLC that the reaction was completed (6 to 48 hours), and cooled to a room temperature. Water (80 mL) was added to the solution, and extraction was conducted with DCM (3×100 mL). An organic phase was dried with anhydrous MgSO₄, a solvent was removed, and a residue was purified by chromatography and dried in a vacuum oven, with a yield of 82%.

### (3) For preparation of (S)-2-(sec-butoxy)-4-methoxybenzoic acid, refer to the preparation of (2) in compound 2

(4) For preparation of 4-((4-nitrophenoxy)carbonyl)phenyl(S)-2-(sec-butoxy)-4-methoxybenzoate, refer to the preparation of (4) in compound 1. ¹H NMR (400 MHz, Chloroform-d) δ 8.37-8.30 (m, 2H), 8.29-8.22 (m, 2H), 8.04 (d, J=8.7 Hz, 1H), 7.47-7.35 (m, 4H), 6.59-6.50 (m, 2H), 4.42 (h, J=6.0 Hz, 1H), 3.89 (s, 3H), 1.82 (ddd, J=13.8, 7.5, 6.2 Hz, 1H), 1.71 (dtd, J=13.8, 7.3, 5.7 Hz, 1H), 1.37 (d, J=6.1 Hz, 3H), 1.01 (t, J=7.4 Hz, 3H).

### Compound 8

For preparation of 4-((4-nitrophenoxy)carbonyl)phenyl(R)-4-(sec-butoxy)-2-methoxybenzoate, refer to the preparation of compound 7.

### Compound 9

For preparation of 4-((4-nitrophenoxy) carbonyl)phenyl(R)-4-methoxy-2-(2-methylbutoxy)benzoate, refer to the preparation of compound 7. ¹H NMR (400 MHz, Chloroform-d) δ 8.37-8.30 (m, 2H), 8.30-8.23 (m, 2H), 8.06 (d, J=8.7 Hz, 1H), 7.47-7.35 (m, 4H), 6.56 (dd, J=8.8, 2.3 Hz, 1H), 6.52 (d, J=2.3 Hz, 1H), 3.96-3.82 (m, 5H), 1.99-1.88 (m, 1H), 1.67-1.59 (m, 1H), 1.36-1.28 (m, 1H), 1.06 (d, J=6.8 Hz, 3H), 0.93 (t, J=7.5 Hz, 3H).

### Compound 10

For preparation of 4-((4-nitrophenoxy)carbonyl)phenyl(S)-2-methoxy-4-(2-methylbutoxy)benzoate, refer to the preparation of compound 7. ¹H NMR (400 MHz, Chloroform-d) δ 8.37-8.30 (m, 2H), 8.28-8.22 (m, 2H), 8.08 (d, J=8.6 Hz, 1H), 7.48-7.35 (m, 4H), 6.62-6.50 (m, 2H), 4.44 (h, J=6.1 Hz, 1H), 3.01-3.93 (s, 5H), 1.86-1.74 (m, 1H), 1.74-1.64 (m, 1H), 1.36 (d, J=6.1 Hz, 3H), 1.01 (t, J=7.5 Hz, 3H).

### Compound 11

For preparation of 4-((4-nitrophenoxy)carbonyl)phenyl(S)-4-methoxy-2-(octane-2-yloxy)benzoate, refer to the preparation of compound 7. ¹H NMR (500 MHz, Chloroform-d) δ 8.37-8.31 (m, 2H), 8.29-8.23 (m, 2H), 8.08 (d, J=8.7 Hz, 1H), 7.47-7.35 (m, 4H), 6.58-6.49 (m, 2H), 4.49 (h, J=6.1 Hz, 1H), 3.93 (s, 3H), 1.82-1.73 (m, 1H), 1.69-1.59 (m, 1H), 1.51-1.37 (m, 2H), 1.36 (d, J=6.0 Hz, 5H), 1.30 (tdd, J=8.8, 5.2, 2.5 Hz, 5H), 0.94-0.85 (m, 3H).

### Compound 12

### Preparation of 3′,4′,5′-trifluoro-2-methoxy-[1,1-biphenyl]-4-yl2,6-difluoro-4-(5-propyl-1,3-dioxane-2-yl)benzoate (4)

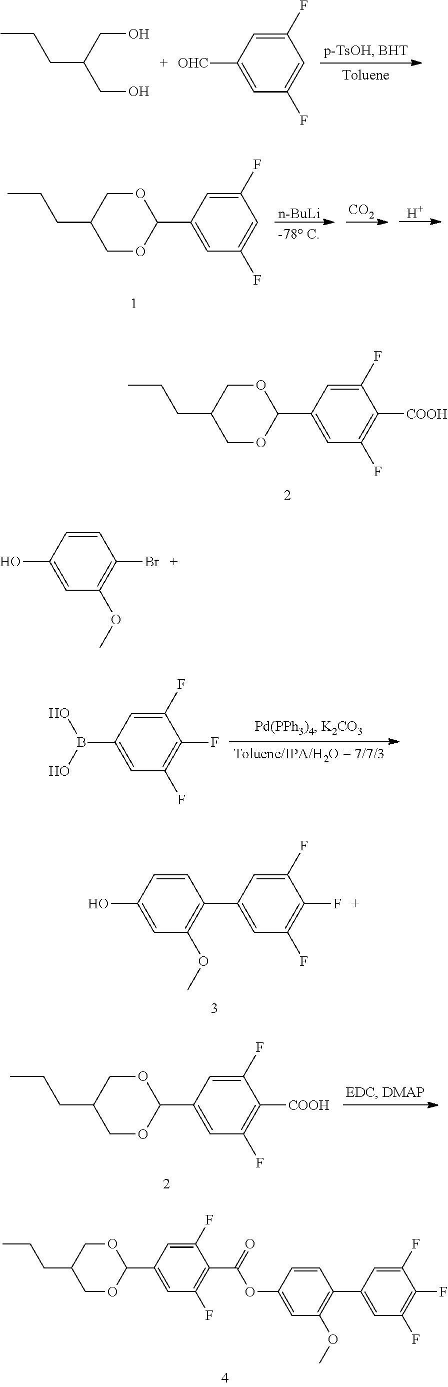

### (1) 2-(3,5-Difluorophenyl)-5-propyl-1,3-dioxane

Under nitrogen atmosphere, 2-propylpropane-1,3-diol (5 g, 42.31 mmol), 3,5-difluorobenzaldehyde (5.01 g, 35.26 mmol), 2,6-di-t-butyl-4-methylphenol (BHT) (116.5 mg, 0.53 mmol) and p-toluene sulphonic acid (p-TsOH) (3.34 g, 19.39 mmol) were refluxed in a toluene solution for 18 to 24 hours. After cooling, washing was conducted with saturated salt water, extraction was conducted with ethyl acetate, and a solvent was spin-dried to obtain 9.86 g of a colorless oily liquid with a yield of 96.2%.

### (2) 2,6-Difluoro-4-(5-propyl-1,3-dioxane-2-yl)benzoic acid

2-(3,5-Difluorophenyl)-5-propyl-1,3-dioxane (1) (10 g, 41.28 mmol) was added to a tetrahydrofuran solution in nitrogen atmosphere, and stirred for 15 minutes at −78° C. Then, 20.64 mL of an n-hexane solution of 2 M butyl lithium was slowly added dropwise within half an hour, and the reaction continued for 3 hours. Then, excess dry ice was put in nitrogen atmosphere or CO₂ gas was introduced to bubble to continue reaction for 1 hour. Finally, pH was adjusted to pH≈1 with a 1 M hydrochloric acid solution. A large amount of a white solid was precipitated from the solution, and the white solid was filtered, and was washed with a large amount of water, and was dried to obtain 10.68 g of a product with a yield of 90.38%.

### (3) 3′,4′,5′-trifluoro-2-methoxy-[1,1′-biphenyl]-4-ol

Under nitrogen atmosphere, 4-bromo-3-methoxyphenol (1 g, 4.93 mmol), (3,4,5-trifluorophenyl)boric acid (1.04 g, 5.91 mmol), and potassium carbonate (2.04 g, 14.78 mmol) were put to a mixed solution of toluene/isopropanol/water with a volume ratio of 7/7/3. Then, tetrakis(triphenylphosphine)palladium (Pd(PPh₃)₄) (57 mg, 0.05 mmol) was added as a catalyst, and reflux reaction was conducted for 14 to 20 hours. After the reaction was completed, 200 mL of water was added for washing, extraction was conducted with ethyl acetate, and then a solvent was spin-dried. Purification was conducted with a chromatographic column to obtain 1.05 g of a colorless crystal with a yield of 83.8%.

### (4) 3′,4′,5′-trifluoro-2-methoxy-[1,1′-biphenyl]-4-yl2,6-difluoro-4-(5-propyl-1,3-dioxane-2-yl)benzoate

Under nitrogen protection, 4-methoxy-2-propoxybenzoic acid (2 g, 6.99 mmol), compound (1) (1.69 g, 6.65 mmol), 1-(3-dimethylaminopropyl)-3-ethylcarbodiimide hydrochloride (1.9 g, 9.98 mmol), and N,N-dimethylaminopyridine (85 mg, 0.66 mmol) were added to 50 mL of anhydrous dichloromethane. The solution was stirred in an ice bath for 1 hour, then gradually restored to a room temperature and continued stirring for 14 to 24 hours. The reaction was monitored by TLC. After the reaction was completed, washing was conducted three times with saturated salt water, and extraction was conducted with ethyl acetate. An organic phase was dried with anhydrous magnesium sulfate, filtered and spin-dried. A crude product was purified by column chromatography with dichloromethane/petroleum ether=2/2 as an eluent, so that 3.09 g of a white solid with a yield of 88.9% was obtained. ¹H NMR (400 MHz, Chloroform-d) δ 7.30 (d, J=8.3 Hz, 1H, ArH), 7.22-7.10 (m, 4H, ArH), 6.94 (dd, J=8.3, 2.2 Hz, 1H, ArH), 6.88 (d, J=2.1 Hz, 1H, ArH), 5.40 (s, 1H, CH), 4.26 (dd, J=11.8, 4.6 Hz, 2H, CH₂), 3.85 (s, 3H), 3.54 (t, J=11.5 Hz, 2H, CH2), 2.23-2.02 (m, 1H, CH), 1.53 (s, 1H, CH), 1.39-1.29 (m, 3H, CH₃), 1.14-1.09 (m, 2H, CH₂), 0.94 (t, J=7.4 Hz, 3H, CH₃).

### Compound 13

2,3′,4′,5′,6-Pentafluoro-[1,1′-biphenyl]-4-yl2,6-difluoro-4-(5-propyl-1,3-dioxane -2-yl)benzoate was prepared by methods similar to those described in compound 12. ¹H NMR (400 MHz, Chloroform-d) δ 7.17-7.10 (m, 2H), 7.05 (ddt, J=8.5, 7.4, 1.2 Hz, 2H), 6.99-6.89 (m, 2H), 5.33 (s, 1H), 4.28-4.13 (m, 2H), 3.57-3.39 (m, 2H), 2.07 (tddd, J=11.4, 9.2, 6.9, 4.6 Hz, 1H), 1.35-1.22 (m, 2H), 1.10-0.98 (m, 2H), 0.87 (t, J=7.3 Hz, 3H).

### Embodiment 1

A preparation method for a polar cholesteric liquid crystal doped with a chiral molecule with a concentration of 10% was as follows:

Using trichloromethane as a solvent, a certain mass fraction of a small chiral molecule and a polar nematic liquid crystal solution were prepared respectively, and then a mixture solution was prepared at a mass ratio of chiral molecule to polar nematic liquid crystal of 1/9. After vacuum drying, a uniform mixture was obtained and labeled as 10% S1/RM734.

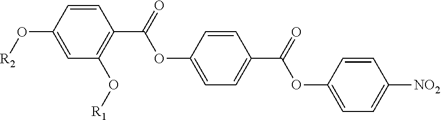

was the polar nematic liquid crystal, where R1 and R2 were methyl groups; and

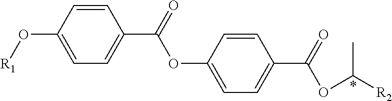

was the chiral molecule, where R1 and R2 were —C6H13.

A phase transition temperature range of a cholesteric phase was determined by using a POM and DSC testing. The effect of chiral dopant concentration on pitch was determined by using a Cano Wedge method.

In particular, a central wavelength λc of a reflection spectrum of circularly polarized light selectively reflected by a cholesteric liquid crystal was related to a pitch (p) of the cholesteric liquid crystal and an average refractive index of liquid crystal, λc=n*p.

### Embodiment 2

A preparation method for a polar cholesteric liquid crystal doped with a chiral molecule with a concentration of 5% was as follows:

Using trichloromethane as a solvent, a certain mass fraction of a small chiral molecule and a polar nematic liquid crystal solution were prepared respectively, and then a mixture solution was prepared at a mass ratio of chiral molecule to polar nematic liquid crystal of 1/19. After vacuum drying, a uniform mixture was obtained and labeled as 5% S1/RM734.

### Embodiment 3

A preparation method for a polar cholesteric liquid crystal doped with a chiral molecule with a concentration of 20% was as follows:

Using trichloromethane as a solvent, a certain mass fraction of a small chiral molecule and a polar nematic liquid crystal solution were prepared respectively, and then a mixture solution was prepared at a mass ratio of chiral molecule to polar nematic liquid crystal of 1/4. After vacuum drying, a uniform mixture was obtained and labeled as 20% S1/RM734.

### Embodiment 4

A preparation method for a polar cholesteric liquid crystal doped with a chiral molecule with a concentration of 30% was as follows: Using trichloromethane as a solvent, a certain mass fraction of a small chiral

molecule and a polar nematic liquid crystal solution were prepared respectively, and then a mixture solution was prepared at a mass ratio of chiral molecule to polar nematic liquid crystal of 3/7. After vacuum drying, a uniform mixture was obtained and labeled as 30% S1/RM734.

### Embodiment 5

A preparation method for a polar cholesteric liquid crystal doped with a chiral molecule with a concentration of 50% was as follows:

Using trichloromethane as a solvent, a certain mass fraction of a small chiral molecule and a polar nematic liquid crystal solution were prepared respectively, and then a mixture solution was prepared at a mass ratio of chiral molecule to polar nematic liquid crystal of 1/1. After vacuum drying, a uniform mixture was obtained and labeled as 50% S1/RM734.

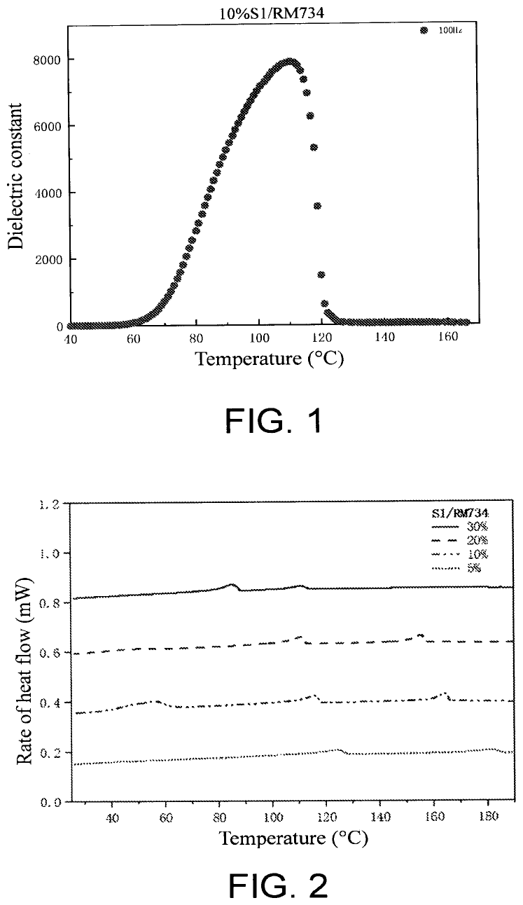

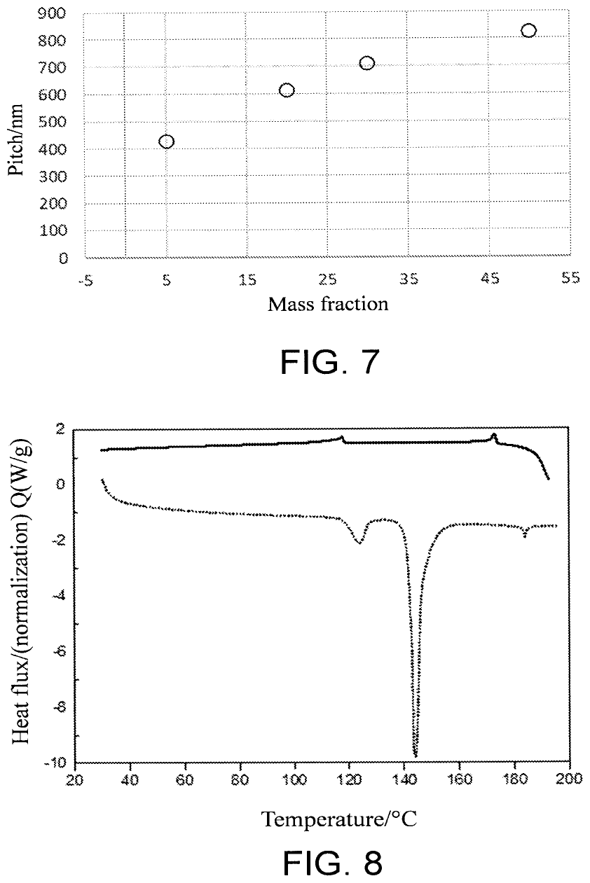

FIG. 1 is a temperature dielectric spectrogram of a cholesteric phase doped with a chiral molecule with a concentration of 10% in Embodiment 1. In FIG. 1, a dielectric constant sharply increases near a phase transition temperature of 120° C. and enters a polar cholesteric phase. FIG. 2 is a DSC graph of chiral molecule doping concentrations of 5%, 10%, 20%, and 30% in Embodiments 1 to 4. A 5% doped sample begins to enter a polar cholesteric phase at 125° C., a 10% doped sample begins to enter the polar cholesteric phase at 120° C., a 20% doped sample begins to enter the polar cholesteric phase at 110° C., and a 30% doped sample begins to enter a polar cholesteric phase at 83° C. FIG. 7 is a pitch measurement graph of chiral molecule doping concentrations of 5%, 20%, 30%, and 50%. A pitch is 427.5 nm in a 5% doped sample, a pitch is 613.9 nm in a 20% doped sample, a pitch is 712.5 nm in a 30% doped sample, and a pitch is 825 nm in a 50% doped sample.

### Embodiment 6

Preparation of a laser was as follows:

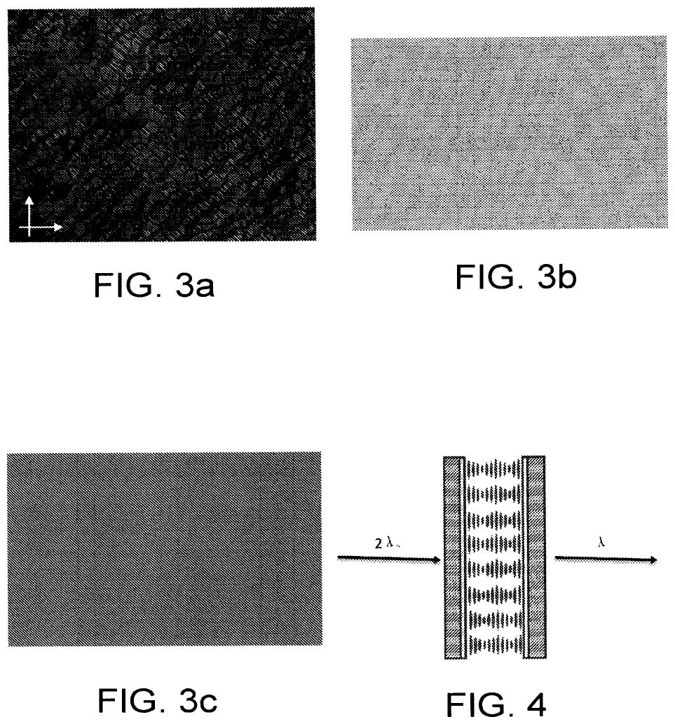

Two polyimide coated glass substrates (1 cm²) were prepared, and subjected to rubbing alignment with a velvet cloth to prepare a liquid crystal cell, with an interval of 5 to 20 micrometers. A prepared cholesteric liquid crystal was heated to a liquid phase, and sucked into the liquid crystal cell under the action of capillary force, and its structure was shown in FIG. 4. FIG. 4 is a schematic diagram of a polar cholesteric phase laser in Embodiment 6. Due to the nonlinear optical effect of a polar cholesteric phase, incident light with a wavelength of 22 was converted into a light wave with a wavelength of λ. Annealing processing was conducted at 400 K for half an hour, so that a stable planar texture is formed in a cholesteric phase (as shown in FIG. 3b and FIG. 3c). FIG. 3b is a polarizing photomicrograph of an annealed planar cholesteric phase in Embodiment 2, and selective reflection at wavelength 430 nm of spectrum can be achieved under the condition of 5% chiral molecule doping. FIG. 3c is a polarizing photomicrograph of an annealed planar cholesteric phase in Embodiment 3, and reflection at wavelength 610 nm of spectrum can be achieved under the condition of 20% chiral molecule doping. Due to the presence of defects during cooling, oily stripe textures will be formed in unannealed planar cholesteric phases during phase transition (as shown in FIG. 3a), which will produce adverse effects on the laser.

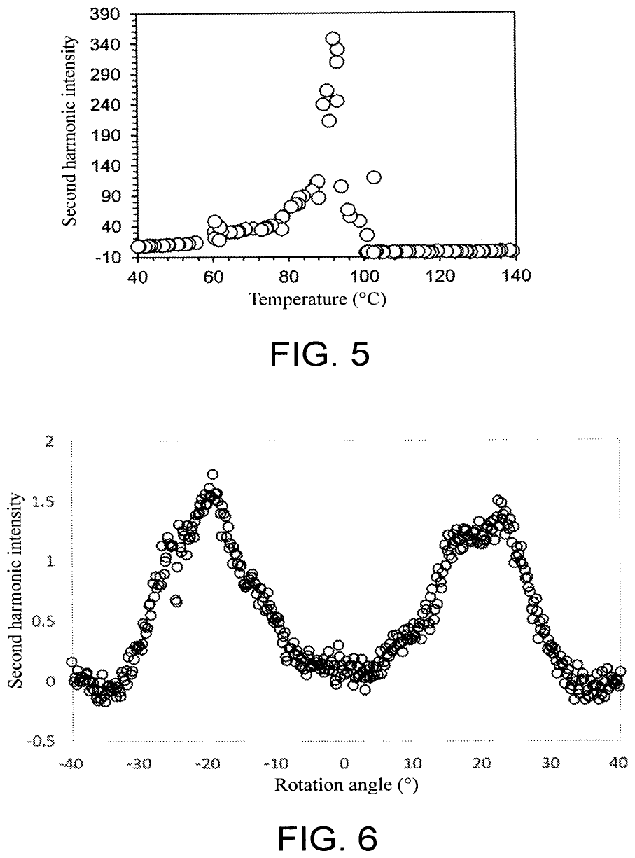

If 1064 nm pulse laser light is used as a light source, due to the nonlinear optical characteristics of a polar cholesteric phase, a 532 nm second harmonic wave will be generated. Correspondingly, the chiral molecule doping concentration is changed to 20%, and the pitch is adjusted to correspond to a selective reflection edge for lasing at 532 nm, so that the effect of second harmonic enhancement is achieved. Emitted second harmonic waves were detected by using a photomultiplier detector to compared with the second harmonic response light intensity of quartz under the same light intensity (as shown in FIG. 5 and FIG. 6), It can be seen from the figures that a y-axis represents second harmonic intensity, and the second harmonic response light intensity of the laser is significantly greater than that of quartz (the SHG intensity of quartz under the same conditions is less than 3).

The above embodiments are preferred implementations of the present invention, but the implementations of the present invention are not limited by the above embodiments. For those skilled in the technical field to which the present invention belongs, without departing from the concept of the present invention, several simple deductions or substitutions can be made, all of which belong to the scope of protection of the present invention.

1. An ultra-high-polarity chiral liquid crystal material, wherein the ultra-high-polarity chiral liquid crystal material has cholesteric phase characteristics, and a formula of the ultra-high-polarity chiral liquid crystal material comprises a polar nematic liquid crystal with a mass ratio of 50% to 95% and a chiral molecule with a mass ratio of 5% to 50%.

2. The ultra-high-polarity chiral liquid crystal material according to claim 1, wherein the formula comprises the polar nematic liquid crystal with a mass ratio of 70% to 95% and the chiral molecule with a mass ratio of 5% to 30%.

3. The ultra-high-polarity chiral liquid crystal material according to claim 1, wherein the polar nematic liquid crystal comprises one or more of the following structural formulas: 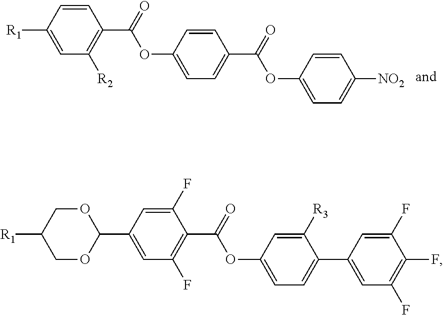
R1, R2, and R3 are alkoxy, alkyl, hydro, or fluoro groups containing 1 to 7 carbon atoms.

4. The ultra-high-polarity chiral liquid crystal material according to claim 1, the wherein a doped chiral molecule comprises one or more of the following structural formulas: 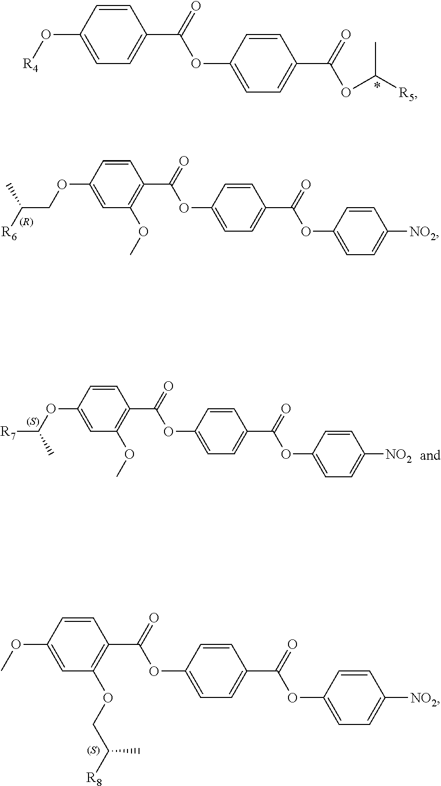
R4, R5, R6, R7 and R8 are alkyl, hydro, or fluoro groups with 1 to 7 carbon atoms.

5. The ultra-high-polarity chiral liquid crystal material according to claim 1, wherein the ultra-high-polarity chiral liquid crystal material has, in a certain temperature range, a high dielectric constant of ε-10⁴ and a characteristic of extremely-strong second harmonic response 3 to 10 times as much as that of a quartz crystal, and a pitch of the ultra-high-polarity chiral liquid crystal material is adjusted within 0.1 to 1 micrometer according to a doped concentration of the chiral molecule.

6. A method for preparing a laser by the ultra-high-polarity chiral liquid crystal material according to claim 1 wherein the ultra-high-polarity chiral liquid crystal material is injected into two glass substrates coated with a polyimide rubbing alignment film, and a spacing between the two glass substrates is 5 to 20 micrometers.

7. The method for preparing a laser according to claim 6, wherein the injected ultra-high-polarity chiral liquid crystal material is subjected to annealing processing for 0.5 to 2 hours under 370 to 440 K, so that a stable planar texture is formed in a cholesteric phase.

8. A liquid crystal laser prepared by the method for preparing a laser according to claim 6, wherein a polar cholesteric phase of the ultra-high-polarity chiral liquid crystal material is planar-oriented, and has a selective reflection spectrum wavelength band adjustable from infrared to ultraviolet at different concentrations of a chiral dopant.

9. A liquid crystal laser prepared by the method for preparing a laser according to claim 6, wherein a polar cholesteric phase of the ultra-high-polarity chiral liquid crystal material is capable of forming ultra-strong second harmonic response light with respect to external excitation light, the external excitation light is amplified by a second harmonic signal in a periodic structure of the polar cholesteric phase and then output as laser light, and wherein no other dye is required for gain.

10. A liquid crystal laser prepared by the method for preparing a laser according to claim 6, wherein the ultra-high-polarity chiral liquid crystal material not only supplies ultra-strong second harmonic response light, but also emits high harmonic response light except second harmonic response light, the ultra-strong second harmonic response light and the high harmonic response light except the second harmonic response light are amplified by a high harmonic signal in a periodic structure of a polar cholesteric phase and then output as laser light or ultra-strong high harmonic signal light, and the liquid crystal laser is equivalent to an efficient organic wavelength conversion device.

11. A method for preparing a laser by the ultra-high-polarity chiral liquid crystal material according to claim 2, wherein the ultra-high-polarity chiral liquid crystal material is injected into two glass substrates coated with a polyimide rubbing alignment film, and a spacing between the two glass substrates is 5 to 20 micrometers.

12. A method for preparing a laser by the ultra-high-polarity chiral liquid crystal material according to claim 3, wherein the ultra-high-polarity chiral liquid crystal material is injected into two glass substrates coated with a polyimide rubbing alignment film, and a spacing between the two glass substrates is 5 to 20 micrometers.

13. A method for preparing a laser by the ultra-high-polarity chiral liquid crystal material according to claim 4, wherein the ultra-high-polarity chiral liquid crystal material is injected into two glass substrates coated with a polyimide rubbing alignment film, and a spacing between the two glass substrates is 5 to 20 micrometers.

14. A method for preparing a laser by the ultra-high-polarity chiral liquid crystal material according to claim 5, wherein the ultra-high-polarity chiral liquid crystal material is injected into two glass substrates coated with a polyimide rubbing alignment film, and a spacing between the two glass substrates is 5 to 20 micrometers.
